(19) United States
(12) Patent Application Publication
(10) Pub. No.: US 2007/0211594 A1
(43) Pub. Date: Sep. 13, 2007

(54) Method of compensating for write power of a light source in an optical disk apparatus and optical disk apparatus using the method

(76) Inventor: Yuichiro Tomishima, Yokahama-si (JP)

Correspondence Address: LEE & MORSE, P.C., 3141 FAIRVIEW PARK DRIVE, SUITE 500, FALLS CHURCH, VA, 22042, US

(21) Appl. No.: 11/643,678

(22) Filed: Dec. 22, 2006

(30) Foreign Application Priority Data
Dec. 26, 2005 (JP) 2005-372962

(51) Int. Cl. G11B 7/125

(52) U.S. Cl. 369/53.26; 369/47.5; 369/53.31

(57) ABSTRACT

A method of compensating for a write power of a laser beam in an optical disk apparatus may include determining whether a predetermined write condition is satisfied, stopping a write operation if the predetermined write condition is not satisfied, measuring a write characteristic of a recording area right before stopping the write operation, and compensating for the write power for recording the information based on the measured write characteristic. The optimum write power of a light source may be compensated for when a current write length exceeds a predetermined write length from a write start location, when a current temperature in a driver is outside a predetermined temperature range, and/or when a reflected light intensity from an optical disk in a write operation is outside a predetermined light intensity range.

### BACKGROUND OF THE INVENTION

1. Field of the Invention

The present invention relates to a method of recording information on an optical disk. More particularly, the present invention relates to a method of compensating for write power of a light source while recording information and an optical disk apparatus performing the method.

2. Description of the Related Art

Optical disks may generally be used as recording media for storing digital information, e.g., data, audio and video. Optical disks may be classified into postscript type optical disks, e.g., compact disc-read only (CD-R), rewrite type optical disks such as CD-RW (read and write), and bulk optical disks, e.g., digital versatile disc (DVD)-R, DVD±R, DVD±RW, and DVD±RAM (random access memory). Current trends include miniaturizing a spot diameter using a high numerical aperture (NA) object lens, using increasingly shorter wavelength light sources, e.g., a semiconductor laser, and using a thin printed circuit board (PCB), which may increase storage capacity of the optical disks and/or decrease optical disk drive size.

Information may be recorded on such an optical disk using a light source, e.g., a laser diode. However, an optimum write parameter may change due to a characteristic of the optical disk and compatibility with an optical disk apparatus. For common optical disks, an optimum write process may be performed by storing write parameters of the common optical disks in firmware of an optical disk apparatus and reading the stored write parameters when information is recorded. That is, when an optical disk is inserted into an optical disk apparatus, unique information, e.g., a disk ID, etc., of the optical disk may be read, and then a write operation for recording information may be performed by specifying a maker and a model of the optical disk based on the read unique information.

However, various kinds of optical disks in addition to common optical disks are available on the market. Furthermore, in view of the development of new optical disks, it is impossible to set optimum write parameters for all optical disks available on the market. Thus, for unknown optical disks, i.e., those whose write parameters are not stored in firmware, a write operation may be performed using a standard write parameter or a write parameter of an optical disk having a close characteristic, e.g., a write parameter of an optical disk of the same maker.

Recently, the amount of data handled by users has increased significantly. Write time is proportional to the amount of information recorded. Thus, in addition to obtaining a desired write quality, a reduced write time, e.g., by realizing a high-speed write operation, may be demanded.

Thus, optical disk makers develop optical disks suitable for high-speed recording, and optical disk apparatus makers develop optical disk apparatuses capable of high-speed recording. In detail, optical disk apparatuses may realize high-speed recording using, e.g., a constant angular velocity (CAV) method, a partial constant angular velocity (PCAV) method, or a zone constant linear velocity (ZCLV) method.

Moreover, even for common optical disks, previously stored write parameters may not be optimal, e.g., due to differences between optical disk apparatuses, individual differences between the optical disks, and/or operational environments. For example, if a write command is received by an optical disk apparatus, e.g., from a personal computer (PC), the optical disk apparatus may perform an optimum power control (OPC) to determine the optimum write power of a light source performing a write operation.

According to the OPC, test recording may be performed in an OPC-exclusive test area using previously stored write parameters, and whether a selected write parameter is appropriate from recorded data may be determined. If the selected write parameter is appropriate, user data may be recorded in a user data area based on the selected write parameter. If the selected write parameter is not appropriate, the write power of a light source may be determined based on a compensated write parameter, and then the data may be recorded in the user data area.

However, even if the optimum write power is selected using the OPC, a write characteristic may be degraded due to an error of the optimum write power generated due to one or more of the following reasons.

First, there may be a difference between surface write characteristics at different locations of an optical disk. This difference may be generated because the write power of a light source, which is optimum when the OPC is performed, may not be the optimum write power in a user data area. In other words, since the surface write characteristic may be different in a test area (OPC area) in which the OPC is performed and a user data area in which information is actually recorded, an error may occur. Since the surface write characteristic may also be different in the surfaces of inner and outer circumferences of the optical disk even in the user data area, an error may occur in the optimum write power across the disk as well.

Second, the write power of the light source may vary in accordance with a temperature of the light source. Since a characteristic of the light source may vary, e.g., due to self-heating generated during data recording or a temperature variation in a disk drive, the write power may correspondingly vary.

Due to the two above-described reasons, the write characteristic may be degraded, thereby generating an error during a write or read operation. In addition, light sources may have different characteristics, e.g., due to individual differences, or the write characteristic may be unstable due to a disk drive.

Conventional techniques attempt to address this issue by holding a write operation at an arbitrary location and restarting the write operation after compensating for the write power to an optimum write power. However, since a compensation process is performed with a fixed address (or write length) in the conventional techniques, the compensation process may be performed even when a such an error does not exist, thereby increasing a write time.

### SUMMARY OF THE INVENTION

The present invention is therefore directed to an optical disk method and apparatus, which overcome one or more of the above disadvantages of the related art.

It is therefore a feature of an embodiment of the present invention to provide a method of compensating for a write power of a light source in an optical disk apparatus to increase write quality by optimizing the write power in a write operation and an optical disk apparatus using the same.

It is therefore another feature of an embodiment of the present invention to provide a method of compensating for a write power of a laser beam in an optical disk apparatus to reduce a write time by optimizing the write power in a write operation and an optical disk apparatus using the same.

At least one of the above and other features and advantages of the present invention may be realized by providing a method of compensating for a write power of a light source in an optical disk apparatus when information is recorded on a recording surface of an optical disk, the method including determining whether a predetermined write condition is satisfied, if the predetermined write condition is not satisfied, stopping a write operation, measuring a write characteristic of a recording area right before stopping the write operation, and compensating for the write power for recording the information based on the measured write characteristic.

The determining may include assessing if a current write length exceeds a predetermined write length from a write start location, assessing if a current internal temperature of a drive of the optical disk apparatus is outside a predetermined temperature, and/or assessing whether a current reflected light intensity is outside a predetermined light intensity range. Two or more of these assessments may occur simultaneously.

When the current reflected light intensity is outside the predetermined light intensity range, compensating may include compensating for the write power of the laser beam in accordance with a difference between reflected light intensity measured before stopping and a target reflected light intensity of a write velocity.

When the current write length exceeds the predetermined write length or the monitored internal temperature of the drive of the optical disk apparatus is outside the predetermined temperature range, measuring may include measuring a Beta value of a recording area in which the information is recorded before stopping, and compensating may include compensating the write power of the laser beam in accordance with a difference between the measured Beta value and a target Beta value of a write velocity.

At least one of the above and other features and advantages of the present invention may be realized by providing an optical disk apparatus for recording information on a recording surface of an optical disk using a predetermined write power, the optical disk apparatus including a write condition analyzer for determining whether a predetermined write condition is satisfied, a write operation stopping unit for stopping a write operation when the write condition analyzer determines that the predetermined write condition is not satisfied, and a write power compensator for measuring a write characteristic of a recording area right before the write operation stopping unit stops the write operation and compensating for the write power for recording the information based on the measurement write characteristic. When compensation of the write power is finished by the write power compensator, the write operation stopping unit may restart the write operation, and the optical disk apparatus may record information on the recording surface of the optical disk using the compensated write power.

At least one of the above and other features and advantages of the present invention may be realized by providing an article of manufacture having a machine-accessible medium including data that, when accessed by a machine, cause the machine to perform a method of compensating for a write power of a light source in an optical disk apparatus when information is recorded on a recording surface of an optical disk, the method including determining whether a predetermined write condition is satisfied, if the predetermined write condition is not satisfied, stopping a write operation, measuring a write characteristic of a recording area right before stopping the write operation, and compensating for the write power for recording the information based on the measured write characteristic.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a functional block diagram of an optical disk apparatus according to an embodiment of the present invention;

FIG. 2 illustrates a conceptual diagram for explaining an OPC area and a user data area in an optical disk according to an embodiment of the present invention;

FIGS. 3A and 3B illustrate a flowchart of a method of compensating for a write power of a laser beam according to an embodiment of the present invention;

FIG. 4 illustrates a correlation between a velocity and a radius when information is recorded using a PCLV method;

FIG. 5 illustrates conventional compensation timing of a write power;

FIG. 6 illustrates another conventional compensation timing of a write power;

FIG. 7 illustrates compensation timing of a write power according to an embodiment of the present invention;

FIG. 8 illustrates compensation timing of a write power according to another embodiment of the present invention;

FIG. 9 illustrates a light source having a temporally varying characteristic;

FIG. 10 illustrates a range of reflected light intensity of the light source of FIG. 9;

FIG. 11 illustrates a table showing target Beta values per write velocity according to an embodiment of the present invention;

FIG. 12 illustrates a table showing target write radio frequency (WRF) values per write velocity according to an embodiment of the present invention;

FIG. 13 illustrates a table showing a compensation coefficient according to an embodiment of the present invention;

FIG. 14 illustrates a correlation between a Beta value and laser power and a correlation between write quality and laser power according to an embodiment of the present invention; and

FIG. 15 illustrates a diagram for explaining a method of obtaining a Beta value according to an embodiment of the present invention.

### DETAILED DESCRIPTION OF THE INVENTION

Japanese Patent Application No. 2005-372962, filed on Dec. 26, 2005, in the Japanese Patent Office, and entitled: “Method of Compensating for Write Power of Laser Beam in Optical Disk Apparatus and Optical Disk Apparatus Using the Method,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

As will be described in detail below, according to embodiments of the present invention, write power may be compensated for by stopping a write process only if necessary, i.e., if a write condition is not satisfied. Thus, write time may be reduced while maintaining high fidelity recording.

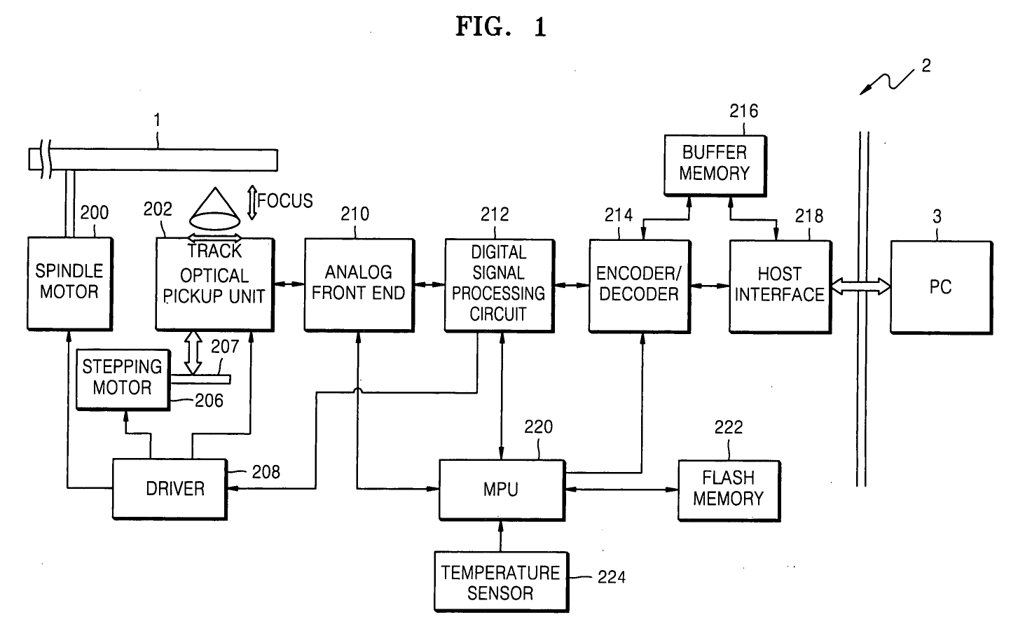

FIG. 1 illustrates a functional block diagram of an optical disk apparatus 2 according to an embodiment of the present invention. Referring to FIG. 1, an optical disk 1 may be a recording medium, e.g., CD-R, CD-RW, DVD±R, DVD-RW, DVD-RAM, etc., on which recording, reproduction, and erase (only for RW and RAM) of information may be performed using a light source, e.g., a semiconductor laser.

A spindle motor 200 may rotate the optical disk 1 with a constant linear velocity or constant angular velocity. A rotational speed of the spindle motor 200 may be controlled by a driver 208.

An optical pickup unit 202 may scan a laser beam on the recording surface of the optical disk 1, on which tracks are formed, and may simultaneously receive light reflected from the recording surface. The optical pickup unit 202 may include a light source, e.g., a laser diode, a collimator lens, a beam splitter, an object lens, a detection lens, an optical receiver, and a driving system, e.g., a focus actuator and a tracking actuator. In the current embodiment, the optical pickup unit 202 may detect the intensity of the light reflected from the optical disk 1 (hereinafter, “the reflected light intensity”) in real time using the optical receiver, and may output the detected reflected light intensity to an analog front end 210.

A stepping motor 206 may move the optical pickup unit 202 in a track direction by driving a slider 207. The stepping motor 206 may be controlled by the driver 208.

The analog front end 210 may be a signal processing circuit for generating a digital signal by processing a detected signal received from the optical pickup unit 202. The detection signal received from the optical pickup unit 202 may be an analog signal. A level of the detected signal may be very low and unstable. Thus, the analog front end 210 may amplify the detected signal and may control a threshold for converting the detected signal into a digital signal. When the analog front end 210 receives the reflected light intensity from the optical pickup unit 202, the analog front end 210 may transmit a level of the reflected light intensity to a microprocessor unit (MPU) 220. The reflected light intensity may correspond to a write radio frequency (WRF).

A digital signal processing circuit 212 may generate an RF signal indicating the sum of reflected light intensity per area of a photo detector (not shown), a focus error signal indicating a focus mismatch of a scan laser (not shown) of the optical pickup unit 202 using, e.g., an astigmatism method, and a tracking error signal indicating a track mismatch of the scan laser of the optical pickup unit 202 using, e.g., a pushpull method. The digital signal processing circuit 212 may also generate a focus driving signal and a tracking driving signal based on the generated focus error signal and tracking error signal, and may output the generated focus driving signal and tracking driving signal to the driver 208.

In addition, when the digital signal processing circuit 212 receives a control command of the spindle motor 200, the optical pickup unit 202, or the stepping motor 206 from the MPU 220, the digital signal processing circuit 212 may output the received control command to the driver 208. When the driver 208 receives the driving signals or the control command, the driver 208 may perform a driving control of the spindle motor 200, the optical pickup unit 202, and the stepping motor 206.

An encoder/decoder 214 may encode information to be recorded on the optical disk 1, which may be received from a PC 3, and may output the encoded information to the digital signal processing circuit 212. The encoder/decoder 214 may decode information read from the optical disk 1, and may output the decoded information to the PC 3.

A buffer memory 216 may temporarily store information received from or to be transmitted to the PC 3. A host interface 218 may perform a connection of a physical level and a signal level with the PC 3.

The MPU 220 may be a main central processing unit (CPU) controlling all components of the optical disk apparatus 2 according to programs and data (firmware) stored in a flash memory 222. In the current embodiment, besides the typical control of the optical disk apparatus 2, the MPU 220 may also stop a write operation when a predetermined write condition is not satisfied. Such predetermined write condition(s) may include when a current write length exceeds a predetermined write length from a write start location, when a temperature from a temperature sensor 224 is outside a predetermined temperature range and/or when the reflected light intensity from the optical disk 1 in the write operation is outside a predetermined light intensity range. When such predetermined write conditions are not met, the MPU 220 may compensate for the optimum write power of the light source. That is, the MPU 220 may have a write condition analysis function of determining whether write conditions are satisfied, a write operation stop function of stopping the write operation if any of the write conditions is not satisfied, and a write power compensation function of compensating for the write power of the light source in the optical pickup unit 202. The temperature sensor 224 may be installed in the optical disk apparatus 2, and may measure an ambient temperature or a self-heating temperature. The temperature sensor 224 may output a current temperature to the MPU 220 in real time.

The flash memory 222 may store programs and data required to operate the MPU 220 as described above. The optical disk 1 may have a unique identification (ID). Thus, the flash memory 222 may store data tables containing optimum write parameters to perform a write operation according to the ID. Tables for compensating for the optimum write power of the light source according to the current embodiment may be included in the data tables. For example, a table of target Beta values according to write velocities, a table of target WRF values according to write velocities, and a compensation coefficient (θ) table may be stored. Since the target Beta table and the target WRF table have different values according to optical disks, the tables may be provided for each disk type or model for common optical disks.

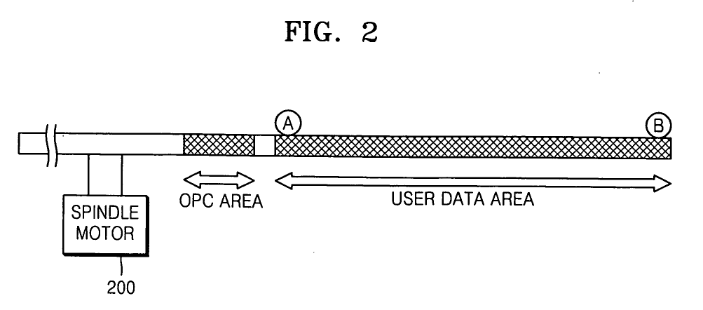

FIG. 2 illustrates a conceptual diagram of an OPC area, in which test recording may be performed before information is recorded on the optical disk 1, and a user data area, in which the information may be recorded, according to an embodiment of the present invention. In the current embodiment, when the optical disk apparatus 2 receives a write command from the PC 3, the optical disk apparatus 2 may check an ID of the optical disk 1, may refer to a write parameter of the light source suitable for the optical disk 1, from the flash memory 222, may determine a write power of the light source based on the write parameter, and may perform test recording in the OPC area. After the test recording is performed, the optical disk apparatus 2 may switch operation mode from a write mode to a read mode, may read the recorded information from the OPC area, and may determine whether the write quality is acceptable using the MPU 220. If the write quality is not acceptable, the optical disk apparatus 2 may compensate for the write power, and may record the information in the user data area using the compensated write power. As described above, in the current embodiment, the OPC may also be performed before user data is recorded.

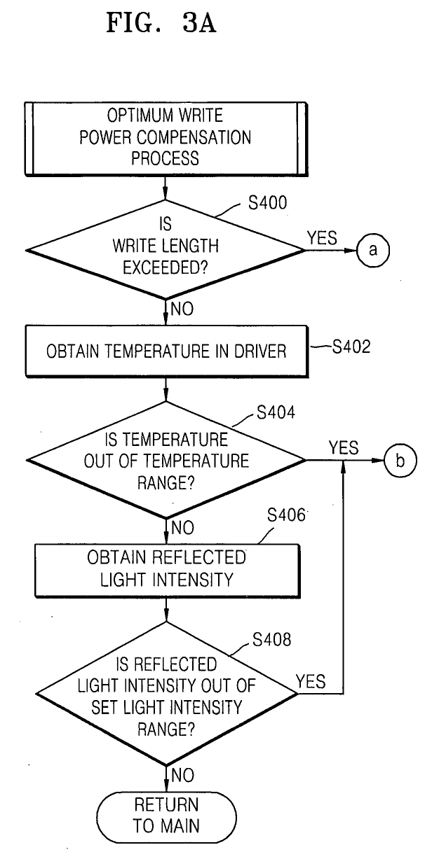

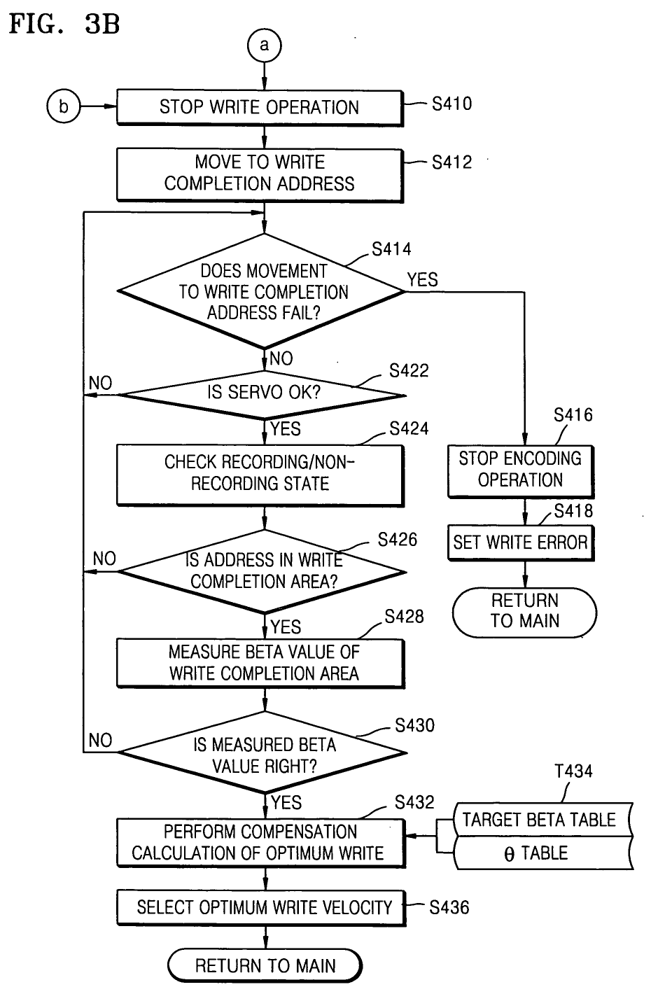

FIGS. 3A and 3B illustrate a flowchart of a method of compensating for a write power of a laser beam according to an embodiment of the present invention. In the current embodiment, the OPC performed before information is recorded in a user data area may be also performed during a write operation. An optimum write power compensation process (intelligent OPC) may be performed only if compensation of a write power of a light source is required. Although a case where the write power compensation process is applied to R-series discs, e.g., a CD-R or a DVD±R, will be described with reference to FIGS. 1, 3A and 3B, the same technical idea may be applied to RW-series discs, next-generation optical disks such as blue-ray disks, and high definition (HD)-DVDs. In addition, the write power compensation process illustrated in FIGS. 3A and 3B may be performed together with a main process performed when the optical disk apparatus 2 records information.

When a write operation begins in the user data area, the MPU 220 determines, in operation S400, whether a current write length exceeds a predetermined write length from a write start location of the optical disk 1. The predetermined write length may be different according to a disk type and a write velocity. If the current write length exceeds the predetermined write length, the MPU 220 may stop the write operation by sending a write operation stop command to the digital signal processing circuit 212 in operation S410.

If the current write length does not exceed the predetermined write length, the MPU 220 may receive a current internal temperature from the temperature sensor 224 in operation S402, and may determine, in operation S404, whether the current temperature is outside of a predetermined temperature range.

If the received temperature value is outside the predetermined temperature range, the process may proceed to operation S410. If the received temperature value is within the predetermined temperature range, the MPU 220 may receive current reflected light intensity of the optical disk 1 from the digital signal processing circuit 212 in operation S406, and may determine, in operation S408, whether the received reflected light intensity is outside a predetermined light intensity range. If the received reflected light intensity is within the predetermined light intensity range, the process may return to operation S400. If the received reflected light intensity is outside the predetermined light intensity range, the process may proceed to operation S410. In FIGS. 3A and 3B, although operations S400, S404, and S408 are sequentially described, operations S400, S404, and S408 may be simultaneously performed, and if any of operations S400, S404, and S408 is satisfied, then the process may immediately proceed to operation S410.

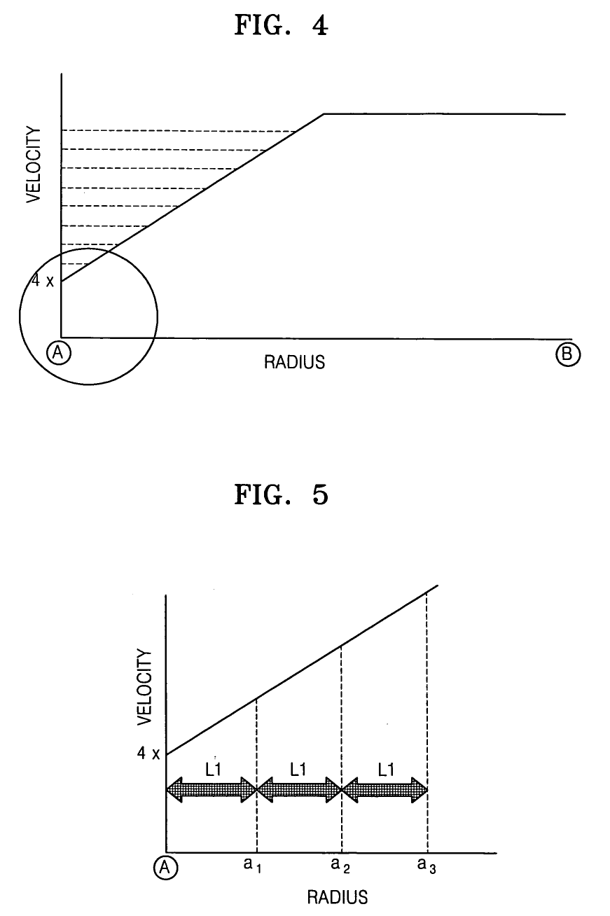

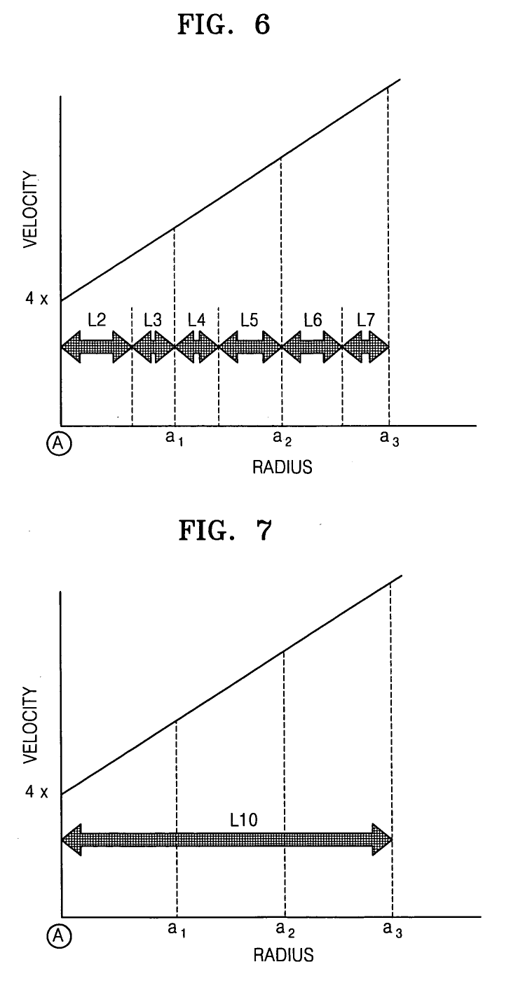

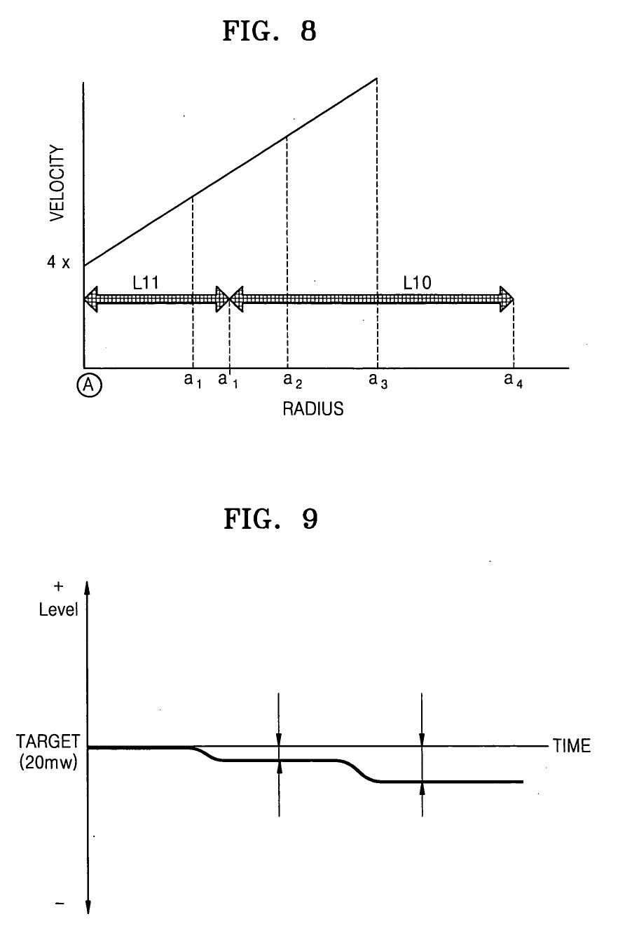

Operation S400 according to an embodiment of the present invention will now be described in detail by comparing it to the related art. FIG. 4 illustrates a correlation between a velocity and a radius when data is recorded on the optical disk 1. In FIG. 4, the write quality may be improved and/or a write time may be reduced by using a PCLV method, e.g., starting with a 4× velocity, increasing the velocity at a CAV, and maintaining a CLV from a recordable critical velocity of the optical disk 1. FIGS. 5 through 8 illustrate magnified views of an encircled portion of FIG. 4. FIGS. 5 and 6 illustrate compensation timings of a write power according to the related art, and FIGS. 7 and 8 illustrate compensation timings of a write power according to embodiments of the present invention.

As illustrated in FIG. 5, in the related art, the optimum write power may be compensated for by stopping a write process at a distance having a fixed write length (or address) L1, and then beginning the write process again. Thus, as illustrated in FIG. 6, if, for example, a write process is finished at a distance having a write length L2 shorter than the fixed write length L1, when a new write process is performed, since the new write process stops at a1 having the fixed write length L1, a continuously recordable distance becomes a write length L3. Thus, as illustrated in FIG. 6, data having the write length L2, data having a write length (L3+L4), data having a write length (L5+L6), and data having a write length L7 are separately recorded, since the optimum write power compensation is performed at every distance having the fixed write length L1, the write processes also stop at a1 and a2.

In operation S400, according to an embodiment of the present invention, since the compensation timing of the write power of the light source is calculated from a write start location, if, for example, the write length (L3+L4) is shorter than the write length L1, a write process does not stop in the middle. In addition, according to an embodiment of the present invention, since operations S404 and S408 may be performed, a write length for stopping a write process may be set to be longer than in the case of performing only operation S400. Thus, as illustrated in FIG. 7, the write length for stopping a write process may be set to, for example, L10.

In addition, as illustrated in FIG. 8, even if a write process is performed at a1 after a previous write process having a write length L11 was finished, the write process may be continuously performed until a4 having the write length L1 without stopping at a3. Thus, in the optimum write power compensation according to embodiments of the present invention, since the number of stopping processes may be reduced compared to the related art, a write time may be reduced.

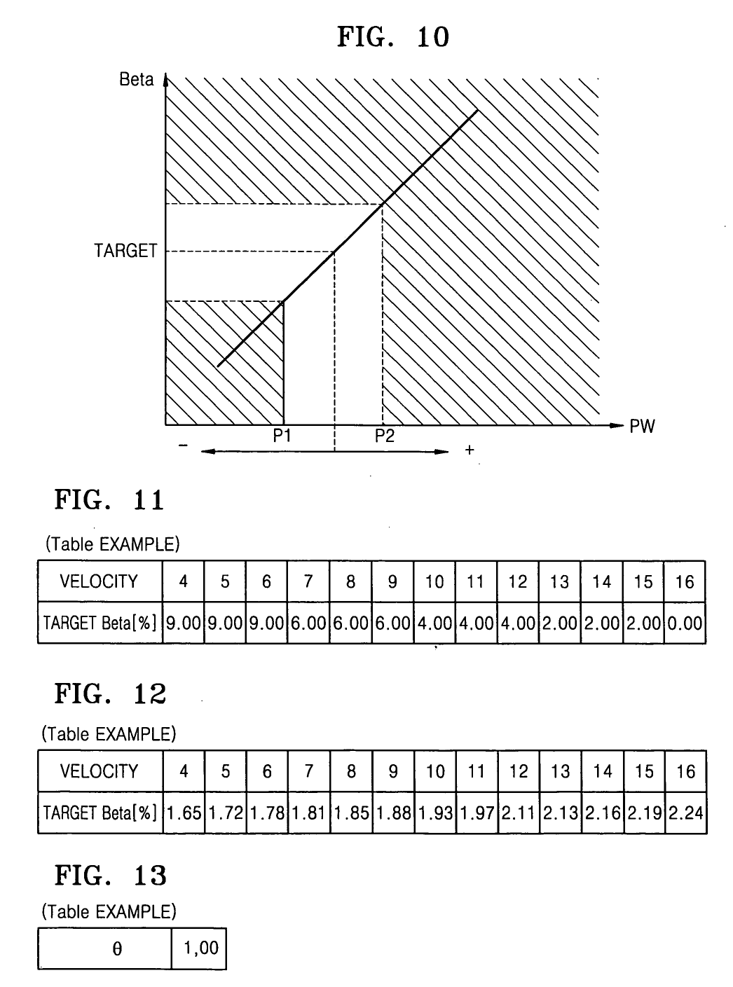

Operation S408 according to an embodiment of the present invention will now be described in detail. Due to a characteristic of the light source, even if the same power is used for the light source, the write power may vary. FIG. 9 illustrates a temporally varying write power of a light source. As illustrated in FIG. 9, for example, a power down may occur in the light source having optimum write power of 20 mW due to, e.g., self-heating, over a period of time. Since reproduction of information is impossible if the write power of the light source is outside a predetermined range, an increase or decrease of the write power of the light source may be detected using the reflected light intensity. That is, as illustrated in FIG. 10, when the reflected light intensity of the case where the write power is outside a range between P1 and P2, a write process may stop, and the write power may be compensated. In addition, since the reflected light intensity may also vary due to a surface write characteristic of the optical disk 1 and an ambient temperature of the optical disk apparatus, even when the surface write characteristic or the ambient temperature is changed, the optimum write power may be compensated for by detecting the reflected light intensity.

Referring back to FIG. 3B, after stopping the write process in operation S410 to compensate for the optimum write power, the MPU 220 may move the optical pickup unit 202 to a write completion address at which a previous write process was performed by controlling the driver 208 via the digital signal processing circuit 212 in operation S412. If the movement to the write completion address fails, and a number of retries exceeds a predetermined value in operation S414, an encoding operation may stop in operation S416, a write error may be set in operation S418, and the process may return to operation S400 in FIG. 3A.

If the movement to the write completion address succeeds in operation S414, the MPU 220 may perform an optical disk servo of the optical pickup unit 202 by controlling the driver 208 via the digital signal processing circuit 212 in operation S422. In detail, the MPU 220 may detect a location of the recording surface of a track in which a signal is recorded by performing a focusing servo, and may perform a tracking control of focusing a beam spot on the recording surface. In operation S424, the MPU 220 may check a recording/non-recording state of a previously stored address. If the MPU 220 cannot perform the tracking control in operation S422, the movement to the write completion address at which the previous write process was performed right before operation S412 is performed may be performed again.

If the previously stored address is in a write completion area in operation S426 as the recording/non-recording state check result of operation S424, the MPU 220 may measure a Beta value of the write completion area from data input from the digital signal processing circuit 212 in operation S428. If the measured Beta value is correct in operation S430, the MPU 220 may perform a compensation calculation of optimum write power by referring to a table T434, which may include a target Beta table and a θ table, stored in the flash memory 222 in operation S432.

FIGS. 11, 12, and 13 illustrate examples of the table T434. FIG. 11 illustrates an example of a table of target Beta values per write velocity, FIG. 12 illustrates an example of a table of target WRF values per write velocity, and FIG. 13 illustrates an example of a table of a compensation coefficient θ. When a current write length exceeds the predetermined write length or when a current temperature is outside the predetermined temperature range, the optimum write power P_{W} of the light source after the compensation is performed may be calculated using the equation P_{W}={(TBeta−MBeta)×MP_{W}}/(θ×100), where TBeta[%] is a target Beta value (referring to FIG. 11), M[%]Beta is a measured Beta value (referring to operation S428 of FIG. 3), MP_{W} is previous write power (write power of the light source measured in operation S428 of FIG. 3B), and θ is a θ value (referring to FIG. 13).

The table of FIG. 12 may be referred to when the current reflected light intensity is outside the predetermined light intensity range in operation S408 of FIG. 3A. In this case, the MPU 220 may compensate for the write power from a difference between measured reflected light intensity and a target WRF value of the table of FIG. 12 corresponding to a velocity at the time when the reflective light intensity is measured. In this case, the MPU 220 may receive a reflected of the reflective light intensity from the analog front end 210, and may determine whether the level is within a predetermined intensity range. After performing the compensation calculation of optimum write power, the MPU 220 may select an optimum write velocity in operation S436, and this process may return to operation S400. If the measured Beta value is wrong in operation S430, this process may return to operation S412, and a Beta value of the write completion area may be measured again.

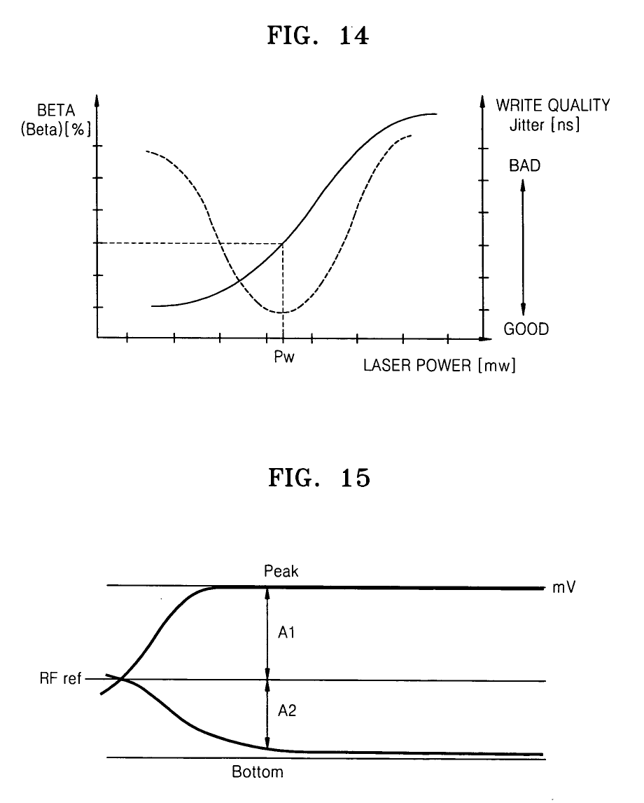

The Beta value is an index of a write characteristic of R-series optical disks, and is correlated with light source power in a write process, as illustrated in FIG. 14. In FIG. 14, for the solid line, the vertical axis denotes Beta (%), and the horizontal axis denotes light source power (mW). FIG. 14 shows that the Beta value increases when the light source power increases. In addition, the dotted line, which indicates write quality (jitter (ns)), shows that the write quality is high when a jitter value is low. Thus, as illustrated in FIG. 14, the write quality is best at a Beta value and a laser power value P_{W} of the case where the jitter value is lowest. In the current embodiment, the light source power may be compensated for so that the jitter value is lowest.

FIG. 15 illustrates a method of obtaining a Beta value according to an embodiment of the present invention. FIG. 15 shows a peak and a bottom of an RF signal. If it is assumed that a height from a reference ref to the peak is A1 and a height from the reference ref to the bottom is A2, the Beta value may be obtained from a recorded RF signal using the equation Beta(%)={(A1−A2)/(A1+A2)}×100.

Although the write power may be compensated for when the current write length exceeds a predetermined write length in operation S400 of FIG. 3A, when the received temperature value is out of the set temperature range in operation S404 of FIG. 3A, or when the received reflected light intensity is out of the set light intensity range in operation S408 of FIG. 3A, all three conditions are not necessarily used together, and one or two of the three conditions may be used.

As described above, according to embodiments of the present invention, since write power may be compensated for by stopping a write process only if necessary, stable write quality can be obtained, and, simultaneously, wasted write time due to stopping of the write process may be reduced or eliminated, thereby reducing the write time and providing a high-performance optical disk apparatus.

Exemplary embodiments of the present invention have been disclosed herein, and although specific terms are employed, they are used and are to be interpreted in a generic and descriptive sense only and not for purpose of limitation. For example, the setting of a write strategy of the present invention may be implemented in software, e.g., by an article of manufacture having a machine-accessible medium including data that, when accessed by a machine, cause the machine to generate compensation strategies in accordance with methods of the present invention. Accordingly, it will be understood by those of ordinary skill in the art that various changes in form and details may be made without departing from the spirit and scope of the present invention as set forth in the following claims.

What is claimed is:

1. A method of compensating for a write power of a light source in an optical disk apparatus when information is recorded on a recording surface of an optical disk, the method comprising:
determining whether a predetermined write condition is satisfied;
if the predetermined write condition is not satisfied, stopping a write operation;
measuring a write characteristic of a recording area right before stopping the write operation; and
compensating for the write power for recording the information based on the measured write characteristic.

2. The method as claimed in claim 1, wherein determining includes assessing if a current write length exceeds a predetermined write length from a write start location.

3. The method as claimed in claim 2, wherein determining includes assessing if a current internal temperature of a drive of the optical disk apparatus is outside a predetermined temperature range.

4. The method as claimed in claim 3, wherein assessing the current write length and assessing the current internal temperature are simultaneous.

5. The method as claimed in claim 1, wherein determining includes assessing whether a current reflected light intensity is outside a predetermined light intensity range.

6. The method as claimed in claim 5, wherein determining includes assessing whether a current internal temperature of a drive of the optical disk apparatus is outside a predetermined temperature range.

7. The method as claimed in claim 6, wherein assessing the current reflected light intensity and assessing the current internal temperature are simultaneous.

8. The method as claimed in claim 6, wherein determining includes assessing whether a current write length exceeds a predetermined write length from a write start location.

9. The method as claimed in claim 8, wherein at least two of assessing the current write length, assessing the current reflected light intensity and assessing the current internal temperature are simultaneous.

10. The method as claimed in claim 6, wherein, when the current reflected light intensity is outside the predetermined light intensity range, compensating includes compensating for the write power of the laser beam in accordance with a difference between reflected light intensity measured before stopping and a target reflected light intensity of a write velocity.

11. The method as claimed in claim 6, wherein, when the current write length exceeds the predetermined write length or the monitored internal temperature of the drive of the optical disk apparatus is outside the predetermined temperature range,
measuring includes measuring a Beta value of a recording area in which the information is recorded before stopping, and
compensating includes compensating the write power of the laser beam in accordance with a difference between the measured Beta value and a target Beta value of a write velocity.

12. An optical disk apparatus for recording information on a recording surface of an optical disk using a predetermined write power, the optical disk apparatus comprising:
a write condition analyzer for determining whether a predetermined write condition is satisfied;
a write operation stopping unit for stopping a write operation when the write condition analyzer determines that the predetermined write condition is not satisfied; and
a write power compensator for measuring a write characteristic of a recording area right before the write operation stopping unit stops the write operation and compensating for the write power for recording the information based on the measured write characteristic,
wherein, when compensation of the write power is finished by the write power compensator, the write operation stopping unit restarts the write operation, and the optical disk apparatus records information on the recording surface of the optical disk using the compensated write power.

13. The optical disk apparatus as claimed in claim 12, the write condition analyzer assesses whether a current write length exceeds a predetermined write length from a write start location.

14. The optical disk apparatus as claimed in claim 13, wherein the write condition analyzer assesses if a current internal temperature of a drive of the optical disk apparatus is outside a predetermined temperature range.

15. The optical disk apparatus as claimed in claim 14, wherein the write condition analyzer assesses the current write length and the current internal temperature simultaneously.

16. The optical disk apparatus as claimed in claim 12, wherein the write condition analyzer assesses whether a current reflected light intensity is outside a predetermined light intensity range.

17. The optical disk apparatus as claimed in claim 16, wherein the write condition analyzer assesses whether a current internal temperature of a drive of the optical disk apparatus is outside a predetermined temperature range.

18. The optical disk apparatus as claimed in claim 17, wherein the write condition analyzer assesses the current reflected light intensity and the current internal temperature simultaneously.

19. The optical disk apparatus as claimed in claim 17, wherein the write condition analyzer assesses whether a current write length exceeds a predetermined write length from a write start location.

20. The optical disk apparatus as claimed in claim 19, wherein the write condition analyzer assesses at least two of the current write length, the current reflected light intensity and the current internal temperature simultaneously.

21. An article of manufacture having a machine-accessible medium including data that, when accessed by a machine, cause the machine to perform a method of compensating for a write power of a light source in an optical disk apparatus when information is recorded on a recording surface of an optical disk, the method comprising:
determining whether a predetermined write condition is satisfied;
if the predetermined write condition is not satisfied, stopping a write operation;
measuring a write characteristic of a recording area right before stopping the write operation; and
compensating for the write power for recording the information based on the measured write characteristic.
